(19) United States
(12) Patent Application Publication
(10) Pub. No.: US 2007/0097096 A1
(43) Pub. Date: May 3, 2007

(54) BIMODAL USER INTERFACE PARADIGM FOR TOUCH SCREEN DEVICES

(75) Inventor: Louis B. Rosenberg, Pismo Beach, CA (US)

Correspondence Address: SINSHEIMER JUHNKE LEBENS & MCIVOR, LLP, 1010 PEACH STREET, P.O. BOX 31, SAN LUIS OBISPO, CA, 93406, US

(73) Assignee: OUTLAND RESEARCH, LLC, Pismo Beach, CA (US)

(21) Appl. No.: 11/626,353

(22) Filed: Jan. 23, 2007

Related U.S. Application Data
(60) Provisional application No. 60/786,417, filed on Mar. 25, 2006.

(51) Int. Cl. G09G 5/00

(52) U.S. Cl. 345/173

(57) ABSTRACT

A touch screen device provides bi-modal user interaction. The touch screen device includes (a) a touch screen interface, (b) a detector to detect an area of finger interaction with the touch screen surface, and (c) a processor. The processor determines, based on at least one of a size, a shape, and an orientation of the detected area of finger interaction, whether a current finger interaction is of one of: a finger-tip interaction type and a finger-pad interaction type. The processor also selects and implements, based on a determined interaction type, one of two different targeting modes, including a first targeting mode selected and implemented in response to a determined finger-tip interaction type and a second targeting mode selected and implemented in response to a determined finger-pad interaction type. In a preferred embodiment, the first targeting mode is direct-targeting mode and the second targeting mode is an offset-targeting mode.

### RELATED APPLICATION DATA

This application claims priority to provisional application Ser. No. 60/786,417, filed Mar. 25, 2006, the disclosure of which is hereby incorporated by reference herein in its entirety.

### FIELD OF THE APPLICATION

The present invention relates to touch screen devices for receiving finger motion inputs from a user.

### BACKGROUND

Touch screens are effective user interface devices for portable computers because they enable a user to interact with graphical user interface content displayed upon a screen without the need for external peripherals such as mice and keyboards. Touch screens can be operated by finger or by a stylus to engage user interface elements. One limitation, however, is that the finger of the user blocks the user's view of the screen and therefore makes it difficult to for the user to see what he or she is pointing at. This problem is reduced when the user employs a narrow stylus, but still can be distracting. In addition, a narrow stylus is often not preferred because it requires that the user employ another piece of hardware that needs to be stored, taken out of a holder for usage, put away after usage, and is often accidentally lost. Thus a finger is more natural and more convenient, but it does present a significant problem in blocking the user's view of the screen, especially on small devices. Upon small handheld devices, a user's finger may block a significant portion of the screen making it difficult to view elements and/or accurately select among graphical elements that are smaller in size than the user's own finger contact area.

When using a traditional touch screen interface, the user selects graphical items of a Graphical User Interface (“GUI”) by placing his or her finger onto the screen location of the graphical items he or she wishes to select. In this way the finger acts as the pointing device, much the same way as a mouse or trackball or touchpad, enabling the control of the targeting location used by the GUI interface based upon user manual input. The big difference, however, is that unlike when a mouse or a trackball or a touchpad, when using a traditional touch screen the user cannot see the graphical element being pointed at (i.e., targeted) because his or her finger blocks some or all of the view of the target item. This makes selection of objects that are small compared to the finger contact area very difficult. This is a very significant problem on the small screens of handheld devices because the GUI is generally scaled down in size such that many objects are displayed small compared to usual finger contact area. There is therefore a need for new user interface paradigms for touch screen computers that enable users to point at objects with their finger in a natural and intuitive way, but not by blocking their view of the object. There is also a substantial need to make such a paradigm a selectable mode, for there are other instances when a user may wish to point directly at the object being selected upon the touch screen interface—for example when objects are large graphical buttons that a user may press upon in the same way he or she would press upon traditional buttons. There is therefore a substantial need for a bimodal user interface methodology for touch screen interfaces wherein a user can (a) selectively employ a traditional touch screen pointing/selecting methodology such that the targeting location is below the contact area of the finger or (b) selectively employ a modified pointing/selecting methodology such that the targeting location is not under the finger contact area and thereby blocked from view.

One touch screen embodiment that attempts to address some problems of touch screen devices is disclosed in U.S. Pat. No. 6,411,283 which is hereby incorporated by reference. This application attempts to address the difficulties that users may face when selecting graphical elements, especially near the edges of a touch screen display. While the disclosed technology does appear to adjust the mapping between finger location and targeting location near the edges of a touch screen display, this art does not provide the user with a bimodal interface such that a user may choose, at will, at any given location upon the screen, among different targeting modes based upon a desired targeting task of the user. In addition, it does not contemplate natural and intuitive paradigms for enabling a user to selectively switch between finger targeting modes, such as a mode selection paradigm that is based upon the specific manner of finger contact upon the touch screen and/or based upon the time duration of finger contact. Thus, this reference does not address the aforementioned need for a user selectable bimodal touch screen interface.

Over the last few years, the tracking technologies employed by touch screen interfaces have become increasingly powerful, enabling faster, higher resolution, and more detailed tracking of finger and/or stylus input. Unfortunately this power has not yet translated into a solution to the above view-blocking problem. In fact, this added power has in some cases created more need for innovative solutions to finger view-blocking. For example, there has been a recent interest in multi-point touch screen devices that enable a user to engage a touch screen with multiple fingers simultaneously. This provides for additional features and flexibility, including multi-finger gestures, but it also increases the amount viewing area that is blocked by a user's hand as he or she engages the touch screen interface with multiple fingers. Such a multi-point touch screen interface is disclosed in U.S. patent application Ser. No. 10/840,862 which is hereby incorporated by reference in its entirety. A variety of multi-finger motions and gestures are disclosed in U.S. Patent Application Publication No. 2006/0026521 which is also hereby incorporated by reference in its entirety. In addition, a method for magnifying a portion of the display upon a touch screen interface is disclosed in U.S. Patent Application Publication No. 2006/0022955 which is also hereby incorporated by reference.

With the introduction of multi-point touch screen technologies and methods, there is an increased need for inventive methods and technologies that enable a user to engage a touch screen through a bi-modal pointing interface wherein a user can selectively engage a specialized targeting mode such that the finger does not block his or her view of the target location.

### SUMMARY

Embodiments of the present invention provide a unique targeting methodology for GUIs implemented upon touch screen devices. More specifically, embodiments of the present invention provide a bimodal targeting paradigm in which a user may naturally and intuitively select between two targeting modes, a traditional targeting mode (referred to herein as direct-targeting) and a modified targeting mode (referred to herein as offset-targeting). Both modes of operation are important for natural user interaction with a touch screen GUI, as direct-targeting is particularly well adapted for user interaction with large graphical elements such as displayed buttons and icons that are of an easily touchable size with respect to the user's finger size. Offset-targeting is well adapted for user interaction with small graphical elements such as text, small buttons, hyperlinks, pixels, and other graphical elements that are small in size with respect to the size of the contact area between the user's finger and the touch screen. Moreover, embodiments of the present invention provide for a natural and seamless method by which the user may selectively switch between modes based upon the manner at which the user's finger contacts the touch screen surface. More specifically, embodiments of the present invention are operative to distinguish between finger-tip interactions (referred to herein as tip-pointing) wherein the user engages the touch screen with the tip of his or her finger and finger-pad interactions (referred to herein as pad-pointing) wherein the user engages the touch screen with the pad of his or her finger. In one embodiment of the present invention, a natural and intuitive paradigm is implemented such that a direct-targeting mode is engaged when it is determined that the user is tip-pointing upon the touch screen and an offset-targeting mode is engaged when it is determined that the user is pad-pointing upon the touch screen interface. In other preferred embodiments, time duration of finger contact is used as a parameter for switching between targeting modes.

Embodiments of the present invention also provide unique methods by which to determine whether a user is performing a tip-pointing interaction with the touch screen or whether the user is performing a pad-pointing interaction with the touch screen. One such method operates by assessing sensor data from the touch screen interface and distinguishing between a plurality characteristic data patterns at the location of contact between the finger and the screen. In such a method, one or more characteristic patterns is associated with fingertip contact and one or more characteristic patterns is associated with a finger pad contact. In some embodiments of the present invention, a user calibration routine may be employed to account for user-to-user and/or finger-to-finger variation in the characteristic patterns.

In some embodiments of the present invention, the distinguishing between finger tip contact and finger pad contact is performed based upon the size and/or shape and/or orientation of the detected contact area between the user's finger and the touch screen. More specifically, a contact area above a certain size level or threshold, either absolute or relative, may be determined to be a pad interaction. Conversely, a contact area below a certain size level or threshold, absolute or relative, may be determined to be a tip interaction. Additionally, the shape of the contact area may also be used as a distinguishing characteristic to determine whether the user is interacting with the tip of his or her finger or with the pad of his or her finger. The orientation of the contact area may also be used as a distinguishing characteristic to determine whether the user is interacting with the tip of his or her finger or with the pad of his or her finger.

In some embodiments of the present invention, the two modes of interaction are strictly binary in nature, meaning that a determination is made that the finger pointing interaction with the touch screen is either tip-pointing or pad-pointing and the mode is abruptly switched between direct-targeting and offset-finger depending upon which type of pointing is detected. In other embodiments, a gradual transition between direct-targeting and offset-targeting is enabled based upon an analog determination as to the degree of tip-pointing versus pad-pointing. This is because there is a range of possible positions that a user's finger may assume between fully tip-pointing and fully pad-pointing. This range of values are generally “moved through” by the user as he or she rolls a finger from the pad up onto the tip, or rolls the finger from the tip down onto the pad. In some embodiments of the present invention, a smooth transition between direct-targeting and offset-targeting may be enabled by gradually adjusting the tracking mode used by the graphical interface from direct-targeting to offset-targeting as the user makes this transition from strictly tip-pointing to strictly pad-pointing.

In some embodiments of the preset invention, a graphical identifier such as an arrow is used to indicate the target location used by the GUI for pointing and selecting at a given moment in time. This graphical identifier may be configured by the present invention to only be displayed during offset-targeting modes. In some embodiments a time threshold may be used in the transition determination between direct-targeting and offset-targeting.

The above summary of the present invention is not intended to represent each embodiment or every aspect of the present invention. The detailed description and figures will describe many of the embodiments and aspects of the present invention.

### BRIEF DESCRIPTION OF THE DRAWINGS

The above and other aspects, features and advantages of the present embodiments will be more apparent from the following more particular description thereof, presented in conjunction with the following drawings wherein:

FIG. 1 illustrates a conventional handheld computer that employs a touch screen configured to perform a direct-targeting user interface;

FIG. 2 illustrates the basic components of the computer shown in FIG. 1;

FIG. 3 illustrates a user engaging a touch screen interface with finger F according to at least one embodiment of the invention;

FIG. 4 illustrates a diagrammatic representation of offset-targeting according to at least one embodiment of the invention;

FIG. 5 illustrates a graphical element that may be drawn upon the touch screen display by routines according to at least one embodiment of the present invention;

FIG. 6 illustrates a finger contact area for a typical interaction between the pad of a user's finger (as opposed to the tip of his finger) and the surface of a touch screen according to at least one embodiment of the invention;

FIGS. 7a, 7b, and 7c illustrate three exemplary finger configurations shown upon a touch screen according to at least one embodiment of the invention;

FIGS. 8A and 8B illustrate two example finger contact areas shown as they might be detected by touch screen sensor hardware according to at least one embodiment of the invention;

FIG. 9 illustrates a flow chart of an example process that may be employed according to at least one embodiment of the present invention;

FIG. 10 illustrates a flow chart for other example processes that may be employed according to at least one embodiment of the present invention; and

FIG. 11 illustrates a touch screen device according to at least one embodiment of the invention.

Corresponding reference characters indicate corresponding components throughout the several views of the drawings. Skilled artisans will appreciate that elements in the figures are illustrated for simplicity and clarity and have not necessarily been drawn to scale. For example, the dimensions of some of the elements in the figures may be exaggerated relative to other elements to help to improve understanding of various embodiments of the present invention. Also, common but well-understood elements that are useful or necessary in a commercially feasible embodiment are often not depicted in order to facilitate a less obstructed view of these various embodiments of the present invention.

### DETAILED DESCRIPTION

Embodiments of the present invention enable a bimodal user interface paradigm to be employed in the tracking of finger input motions upon touch screen interfaces. More specifically, the embodiments of the present invention are operative to distinguish between at least two distinct forms of finger interactions with touch screen, including finger-tip interactions wherein the tip of a user's finger engages the screen and finger-pad interactions wherein the pad of a user's finger engages the screen. In one embodiment, two different types of finger input control paradigms are performed based upon the form of the finger interaction, performing a direct-targeting input paradigm for tip interactions and offset-targeting input paradigm for pad interactions. Such paradigms allow a user to selectively engage graphical user interface elements upon a touch screen without blocking the view of his or her finger. Embodiments of the present invention may employ a variety of methods for distinguishing between finger-tip interactions and finger-pad interactions, including an assessment of the finger contact area size, shape, and/or orientation.

Embodiments of the present invention provide a bimodal user interface methodology for touch screen interfaces where a user can selectively employ a traditional touch screen pointing methodology such that the targeting location used by the GUI is below the contact area of the finger or can selectively employ a modified pointing methodology such that the targeting location is not under the finger contact area and thereby blocked from view. In addition, embodiments of the present invention enable mode selection in a particularly natural and intuitive manner, based upon the orientation in which the user's finger engages the touch screen.

A traditional touch screen interface enables a user to provide input to a graphical user interface (GUI) by manually touching the surface of the screen as a means of targeting and selecting displayed graphical elements. For example, if a user wants to target and select a particular icon, button, hyperlink, menu element, or other displayed element upon the screen, the user touches the actual location upon the screen at which that desired element is displayed. In some instances the user touches the desired element to both target and select it. In other instances, a two step process is used in which a user first targets the item by touching it and then selects it by performing another action such as pressing upon it with more than a certain threshold amount of force. These two steps are sometimes referred to as “targeting” and “clicking.” Whether the process is performed in two steps or one, the traditional GUI implemented upon a touch screen interface requires a user to manually touch the displayed location of a graphical element as part of the selection process. To select a displayed button upon the screen, the user touches the location upon the screen where the button is displayed. As used herein, the location within a graphical user interface that a user must identify to select a graphical element is referred to as a “target location.” Thus, the traditional way in which a graphical user interface is implemented upon a touch screen interface is such that a user must select a graphical element at a desired target location by directly touching that target location upon the screen. This process is referred to herein as “direct-targeting.”

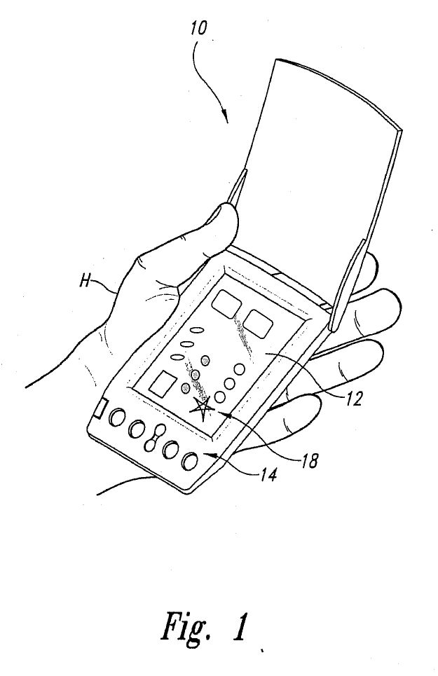

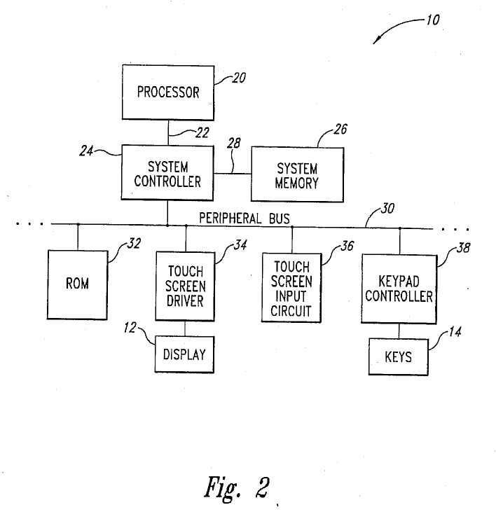

By way of example, FIG. 1 illustrates a conventional handheld computer 10 that employs a touch screen configured to perform a direct-targeting user interface paradigm. The basic components of computer 10 are shown in the system block diagram of FIG. 2 and are discussed in more detail below. As shown in FIG. 1, computer 10 is of the type that is adapted to be held in one hand H of an operator during typical use. Such computers 10, often known as “palmtop” computers, include a display screen 12 that takes up a large portion of the frontal surface area but is still relatively small compared to a traditional desktop computer. Because the screen is generally made as large as can reasonably be fit within the handheld size of the device, relatively few manually actuated keys are provided as indicated as 14. The display screen 12 is a touch screen that is used as the primarily controls the operation of the computer 10. A graphical user interface is displayed upon the screen, including buttons, icons, sliders, menus, and other GUI elements known to the art. As an example, several buttons and icons 18 are displayed on the screen 12. In normal operation, programs or other functions are selected by the user touching the screen 12 at the location of a button, icon, or other graphical element 18 that corresponds to the desired program or function to be selected. Because some of the elements are small as compared to the size of the user's finger, those elements will be difficult to select by the user using a direct-targeting interaction paradigm with his or her finger upon the touch screen. As a result, users of such devices often need to use a stylus for accurate targeting of small graphical elements. Unfortunately, the use of a stylus is often not always preferred because it requires that the user employ another piece of hardware that needs to be stored, taken out of a holder for usage, put away after usage, and is often accidentally lost. In addition, a stylus is often not convenient for touch screen interfaces that enable multi-point targeting and multi-finger gesturing because a user can not easily hold a stylus at the same time he or she is performing a multi-finger gesture. Thus there is a need for an alternate means of finger targeting of graphical elements upon touch screen interface that enables a user to select elements that are small in size relative to his or her finger without needing a stylus. There is also a need for a natural and intuitive paradigm by which user's can switch back and forth between direct-targeting and this alternate targeting mode.

Embodiments of the present invention address this need by providing a bimodal targeting paradigm in which a user may naturally and intuitively select between two targeting modes, a traditional targeting mode (i.e., direct-targeting) and a modified targeting mode (referred to herein as “offset-targeting”). As described herein, both modes of operation are important for normal user interaction with a touch screen GUI, as direct-targeting is particularly well adapted for user interaction with large graphical elements such as displayed buttons and icons that are of an easily touchable size with respect to the user's finger size, while offset-targeting is well adapted for user interaction with small graphical elements such as text, small buttons, hyperlinks, pixels, and other graphical elements that are small in size with respect to the size of the contact area between the user's finger and the touch screen. In addition, embodiments of the present invention provide a particularly natural and seamless method by which the user may select modes and/or switch between targeting modes based upon the orientation at which the user's finger contacts the touch screen surface. More specifically, embodiments of the present invention are operative to distinguish between finger-tip interactions (referred to herein as “tip-pointing”) where the user engages the touch screen with the tip of his or her finger and finger-pad interactions (referred to herein as “pad-pointing”) where the user engages the touch screen with the pad of his or her finger. In one preferred embodiment of the present invention, a natural and intuitive mapping is implemented such that a direct-targeting mode is engaged when it is determined that the user is tip-pointing upon the touch screen and an offset-targeting mode is engaged when it is determined that the user is pad-pointing upon the touch screen interface.

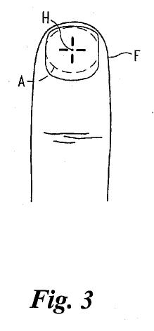

As described above, direct-targeting is the traditional mode of finger interaction with touch screen interfaces. Direct-targeting, however, although natural for large elements upon the screen, has a significant limitation when it comes to targeting small objects upon the screen. This is because the target location used by the GUI during direct-targeting is a location that is directly under the user's finger (i.e. within the area of contact between the user's finger and screen). This area is referred to herein as the finger contact area and is shown by example in FIG. 3. FIG. 3 illustrates a user engaging a touch screen interface with finger F according to at least one embodiment of the invention. The finger F contacts the screen surface across a finger contact area A that is generally an elliptical shape caused by depression of the user's finger as it engages the screen. As shown, the finger contact area A is directly under user's finger and thus corresponds with a screen location that is obscured from view. In traditional touch screen interfaces the specific location used for GUI targeting is at or near geometric center of the finger contact area. For example, the center location H is commonly used for GUI targeting. Thus, if a user wants to select a graphical button that is displayed upon a touch screen interface, the user must directly touch the location of the graphical button so as to target it (i.e., engage it with center location H of finger contact area A). This action will obscure much, if not all, of the button from view during the touch interaction. This may not be a problem for a large graphical button, but it is a significant problem for displayed objects that are smaller than the user's finger contact area. For example, if the user of a direct-targeting touch screen interface wanted to select a particular letter within a word displayed by a word processing application, and if that letter was smaller than the size of the user's finger contact area, it would be very difficult for the user to select the correct letter because much of the word would be obscured from view by the user's own finger. Even if the resolution of the touch screen interface was sufficient accurate to enable precise identification of target locations, the fact that the user's own finger blocks his or her view of the graphical target makes the selection process very difficult. Therefore, while direct-targeting may be a preferred method of interaction for certain displayed graphical elements within a touch screen GUI, this method is highly problematic for objects that are small relative to the size of a user's finger. The problem is made worse upon handheld devices with small screens because many graphical elements are displayed at small sizes relative to the size of the user's finger. There is therefore a substantial need for an alternate user interface paradigm to replace and/or supplement direct-targeting with a finger upon touch screen GUI interfaces. There is also a substantial need for enabling natural and intuitive mode selection between direct-targeting and the alternative user interface paradigm.

To address the above stated need, embodiments of the present invention provide an additional targeting mode for touch screen GUIs such that the target location used by the GUI is not a location within the finger contact area (i.e., the area of contact between the finger and screen), but instead is a location upon the screen that is an offset distance away from the finger contact area. More specifically, the target location used by the GUI is a location upon the screen that is directly ahead of the user's finger (i.e., a location upon the screen that is an offset distance forward of tip of the user's finger). The distance between the center of the finger contact area (i.e., the traditional target location used by touch screen GUI interfaces) and the target location used by this interaction mode is referred to herein as the offset distance. Thus, embodiments of the present invention enable an offset distance to be intelligently employed that shifts the target location used by the touch screen GUI from below the finger (i.e., within the finger contact area) to a new location in front of the finger. In addition, a graphical element is drawn upon the screen at the offset target location, visually identifying the targeting location to the user. This enables the user to visibly view the target location upon the screen as he or she interacts, thereby not suffering the traditional problem of having the target location obscured from view by the user's own finger. This interaction mode is referred to herein as “offset-targeting.”

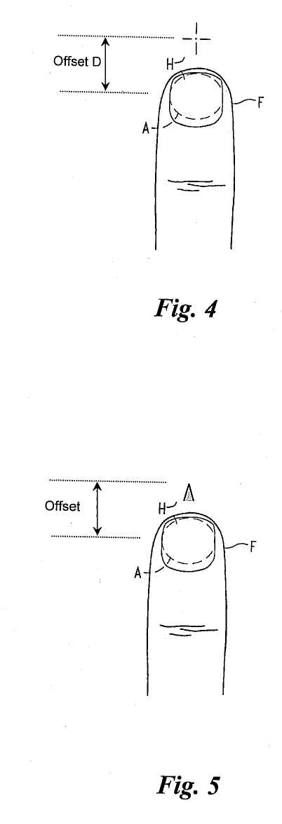

FIG. 4 illustrates a diagrammatic representation of offset-targeting according to at least one embodiment of the invention. As shown, the user engages the surface of a touch screen interface with finger F. The finger contact area is shown by the dotted elliptical region A. Rather than using the center of region A as the targeting location (or any point within finger contact area), this embodiment of the invention uses offset location H as the targeting location. Offset location H, as represented by the crosshairs, is located in front of the finger (i.e., forward of the tip of the finger) by an offset distance D. Offset distance D may be a fixed value and is generally chosen as a value that is just large enough such that the user can conveniently view the targeting location but small enough that the location seems to the user as clearly relationally associated with the user's finger. Offset distance D may also be user selectable and/or user adjustable through a configuration process. Offset distance D may also be adjusted automatically over a range of values based upon an analog determination of the user's engagement of the touch screen as it varies between tip-pointing and pad-pointing, as described in detail below.

FIG. 5 illustrates a graphical element that may be drawn upon the touch screen display by routines according to at least one embodiment of the present invention such that it visually indicates the targeting location employed by the offset targeting mode. The graphical element may take many forms, although a preferred embodiment is an arrow that points away from the user's finger F, the point of the arrow being located at or substantially at the offset targeting location. In this way the graphical arrow does not obscure or substantially GUI elements being pointed to by the user. Thus, this embodiment of the invention is operative to draw the graphical arrow such that (a) the tip of the arrow is pointing at or substantially at the offset targeting location H, and (b) the body of the arrow is located substantially in the area between the user's finger and the offset targeting location H. In general, the pointing axis of the arrow is orientated along an imaginary line drawn from the approximate center location of the finger contact area A to the offset targeting location H.

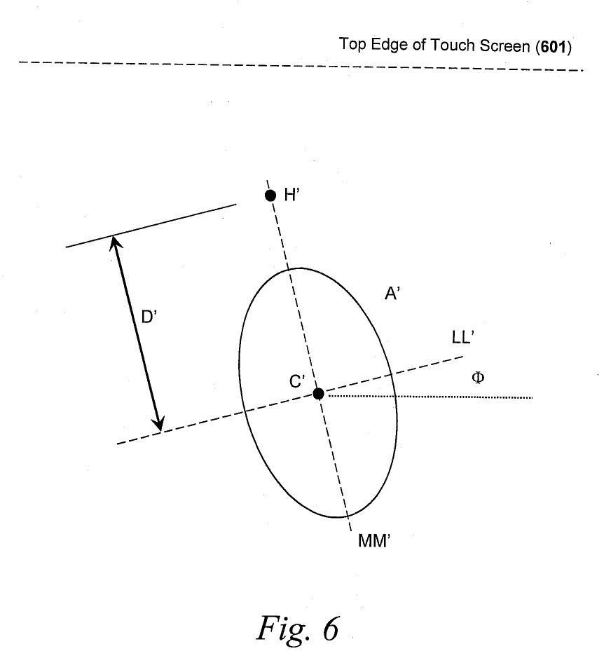

It should be noted that in many embodiments of the present invention, the offset targeting location H is computed such that it is forward of the user's finger F by offset D based upon an assessment of the shape and orientation of finger contact area A. This is generally also performed based at least in part upon an assessment as to which side of the screen is the upper edge and which side of the screen is the lower edge. It is generally assumed that the user's finger will always be pointing in a direction that is roughly upward upon the screen, thus ambiguity between which side of the finger contact area is the side forward of the user's finger is easily assessed. An example of how these assessment and computations may be performed is discussed below with respect to FIG. 6.

FIG. 6 illustrates a finger contact area for a typical interaction between the pad of a user's finger (as opposed to the tip of his finger) and the surface of a touch screen according to at least one embodiment of the invention. The touch screen of the figure is oriented such that the top edge of the touch screen is represented by dotted line 601. It should be noted that the top edge of the touch screen may be a permanent designation for devices that are always held in a certain orientation. Alternatively, the top of edge of the touch screen may be defined by the GUI and may be selectable in different modes wherein the display is oriented differently depending upon the mode. Alternatively, the handheld computing device may include an orientation sensor such as an accelerometer that is used to determine based in whole or in part upon the acceleration reading of the direction of gravity, which edge of the display is to be considered the top edge for the purposes of finger interaction upon the touch screen display. Whichever method is used, the current description of FIG. 6 assumes that dotted line 601 represents the top edge of the touch screen surface as it is oriented with respect to the user.

The touch screen interface electronics detect the contact area of the user's finger upon the surface of the touch screen as it shown in FIG. 6. The finger contact area is represented by outline A′ and indicates the roughly elliptical shape that is characteristic of finger interactions upon touch screen surfaces. It should be noted that the finger is touching the screen at a planar orientation represented by angle Φ in FIG. 6. Based upon the size and/or shape of the ellipse, the routines of this embodiment determine that the user is pad-pointing as opposed to tip-pointing upon the touch screen. This determination is described in more detail below. Because the user is pad-pointing, the targeting location to be used by the GUI is an offset target location H′ that is located an offset distance D′ in front of the finger (i.e., forward of the nail of the user's finger). Thus, the embodiment shown in FIG. 6 demonstrates one method by which such an offset target location may be determined.

For the example represented in FIG. 6, the finger contact data received from the touch screen interface represents a roughly elliptical finger contact area A′. The routines according to the embodiment of the present invention perform a mathematical analysis upon the finger contact area A′ to find the center point C′ of the finger contact area and two lines (MM′ and LL′) that symmetrically bisect the ellipse through the center point. These two lines are generally referred to as the major axis of the ellipse and the minor axis of the ellipse. Since the user is then currently pad-pointing, the major axis of the ellipse (i.e., the longer axis across the ellipse) is orientated substantially along the length of the finger and the minor axis (i.e., the shorter axis across the ellipse) is orientated substantially along the width of the finger. Thus, in FIG. 6 the major axis is represented by line MM′. To mathematically find the offset target location, a routine finds the major axis MM′ and then projects a point from the center point C′ along the major axis MM′ by an offset distance D. This computation yields the point within the graphical user interface represented by H′. In other words, this embodiment assesses the contact area upon the touch screen and computes a target location within the graphical user interface that is offset from the center point C′ of the contact area along the major axis MM′ by an offset distance D.

The process described above has a mathematical ambiguity as to which direction along major axis MM′ the offset target location should be projected away from center location C′. There are two possibilities—one possibility that is correctly in front of the finger and one possibility that is deeper under the finger. Embodiments of the present invention solve this mathematical ambiguity by selecting the solution that is nearer to the top edge of the screen 601. This is because it is highly unlikely that a user, while pad-pointing with his or her finger, will have his finger aimed downward upon the screen because this is an awkward configuration for the user's hand.

If a user were to position his or her finger perfectly horizontally upon the screen while pad-pointing (i.e., a position such that planar angle Φ is 90 degrees), both possible solutions for the offset target location would be equidistant from the top edge of the screen. This creates another ambiguity. This ambiguity may be solved correctly in most cases by considering a time-history of computed offset target locations in the recent past. This is because during continuous operation (i.e., during a period when the user is sliding his or her finger over the screen in a pointing interaction), the location of the offset target location should not suddenly jump but should change location smoothly (unless it is determined that the user has lifted his finger from contact). Thus, a time history of recent data can be used to help resolve ambiguities as to which side of the elliptical contact area is in fact in front of the user's finger. This process can be used even if the user's finger does begin to aim downward upon the screen in an awkward configuration so long as the user began the fingering motion in a traditional upward facing finger orientation.

The routines of the present invention can therefore quickly and easily determine, based upon touch pad contact data, the offset target location to be used by the GUI during an offset-targeting mode. This offset target location is roughly located upon the touch screen at a distance D′ in front of the center C′ of contact area A′ along axis MM′. Because the data may not represent a prefect ellipse, the location may be roughly computed rather than precisely computed, but this is generally not a problem for a human user. In addition, once the offset target location is computed, a graphical indicator is generally drawn by the routines of the present invention to indicate to the user the current position of the offset target location. This graphical indicator may take a variety of forms, although one preferred implementation is an arrow with the point at or near offset location H′ and oriented along axis MM′ with the body of the arrow being located between offset location H′ and the tip of the user's finger.

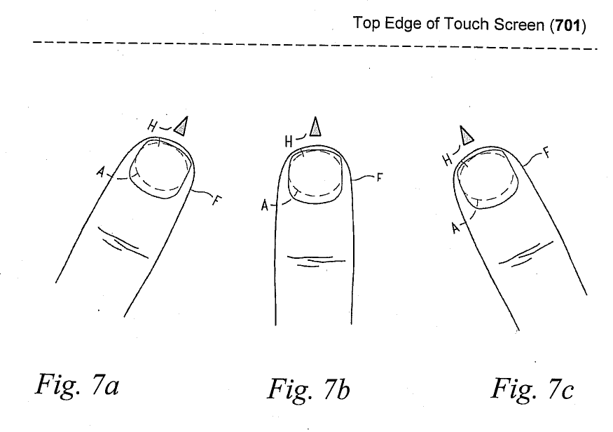

FIGS. 7a, 7b, and 7c illustrate three exemplary finger configurations shown upon a touch screen according to at least one embodiment of the invention. Each finger configuration shows a finger a different planar orientation upon the screen. As is shown, the methods of according to the present invention compute the offset target location and position the graphical indicator with consideration for the planar orientation. This creates a very natural and intuitive interface wherein the graphical pointer tracks not just the position of the user's finger upon the screen, but varies appropriately with the planar orientation of the finger as it engages the screen. Thus, by moving his or her finger about the screen in a pad-pointing interaction, the user can freely position the point of the offset graphical arrow. This enables accurate targeting using a finger such that small graphical elements, such as individual letters in a textual display, may be pointed at and selected without the users' finger itself obscuring the view of the target elements.

A variety of methods may be used to indicate selection of an item that is pointed at. For example in some embodiments, increased force applied by the finger may be used such that force above a certain threshold and/or applied with certain timing characteristics are interpreted by the routines of the interface as an indication of a “click”—i.e., a selection. In other embodiments the user may momentarily lift and tap the finger in place to indicate a “click.” In other embodiments an interaction by an alternate finger may be used in combination with the pad-pointing action of the current finger to indicate a “click”, for example another finger pressing a real or displayed button to indicate the click selection action. A voice command may also be used in combination with the pad-pointing action of the current finger to indicate a “click.” For example, the user may utter “select” while pointing the aforementioned arrow at a desired GUI element using the pad-pointing mode described herein.

Thus, the offset-targeting mode, as disclosed herein, solves many problems associated with touch screen interfaces, especially touch screen interfaces of small handheld devices. However, there are other situations where the user may wish to directly touch objects, for example, by touching large buttons upon the graphical display. Thus, there is a need for a natural and intuitive paradigm by which a user can selectively switch between direct-targeting and offset-targeting. These two modes can be conceptualized as a course targeting mode where a user's finger is a good size for directly targeting a graphical element and a fine targeting mode in which a user's finger is too big to reasonably hit targets. Thus, there is a significant need for a natural and intuitive paradigm by which a user can shift between course finger targeting using a direct-targeting paradigm and fine finger targeting using an offset targeting paradigm. Embodiments of the present invention provide such two modes of operation and provide a natural and intuitive method for switching between them. More specifically, embodiments of the present invention provide a unique bimodal methodology in which both direct-targeting and offset-targeting modes of interaction are provided to the user and may be alternately selected at will. Even more specifically, the embodiments enable a user to select between offset-targeting and direct-targeting based upon the manner in which the user's finger vertically engages the touch screen. By the manner in which the user vertically engages the screen, it means the orientation in which the finger touches the screen in the direction out of the plane of the screen (i.e., the orientation that the finger approaches the screen from above the plane of the screen). Even more specifically, the embodiments enable the user to switch between offset-targeting and direct-targeting based upon whether the user is engaging the touch screen with the tip of his finger or if the user is engaging the touch screen with the pad of his finger. As used herein, “tip-pointing” refers to the situation where a user contacts the screen with the tip of his finger and “pad-pointing” refers to the situation where the user contacts the screen with the pad of his finger. Thus, the embodiments of the present invention are operative to determine, based upon sensor data from the touch screen interface, whether the user is currently tip-pointing or pad-pointing upon the touch screen, and then selects one of direct-targeting and offset-targeting based upon the determination.

In one particular embodiment, the routines are configured such that a unique and intuitive mapping is provided as follows: a direct-targeting mode of interaction is employed when it is determined that the user is tip-pointing upon the touch screen interface and such that an offset-targeting mode of interaction is employed when it is determined that the user is pad-pointing upon the touch screen interface. This is a particularly intuitive paradigm because when a user is tip-pointing, his or her finger is pointed substantially into the plane of the screen and thus it makes intuitive sense to a user that targeting location be employed that is directly below the finger (i.e., within the finger contact area). On the other hand, when pad-pointing, the user's finger is pointed substantially parallel to the plane of the screen and thus it makes intuitive sense to a user that the targeting location used by the GUI be in front of the finger (i.e., ahead of the tip of the finger) by some offset distance. Thus, the embodiments are operative to enable two targeting modes upon a touch screen interface: a direct-targeting mode that is engaged when a user performs tip-pointing interactions and an offset-targeting mode that is engaged when a user performs pad-pointing interactions. These two modes are enabled by specialized software routines employed upon a touch screen enabled computer device, such as computer device 10 of FIG. 1.

The basic components of computer 10 are shown in the system block diagram of FIG. 2. The computer 10 includes a processor 20 of conventional design that is coupled through a processor bus 22 to a system controller 24. The processor bus 22 generally includes a set of bidirectional data bus lines coupling data to and from the processor 20, a set of unidirectional address bus lines coupling addresses from the processor 20, and a set of unidirectional control/status bus lines coupling control signals from the processor 20 and status signals to the processor 20. The system controller 24 performs two basic functions. First, it couples signals between the processor 20 and a system memory 26 via a memory bus 28. The system memory 26 is normally a dynamic random access memory (“DRAM”), but it may also be a static random access memory (“SRAM”). Second, the system controller 24 couples signals between the processor 20 and a peripheral bus 30. The peripheral bus 30 is, in turn, coupled to a read only memory (“ROM”) 32, a touch screen driver 34, a touch screen input circuit 36, and a keypad controller 38.

The ROM 32 stores a software program for controlling the operation of the computer 10, although the program may be transferred from the ROM 32 to the system memory 26 and executed by the processor 20 from the system memory 26. The software program may include the specialized routines described herein for enabling the bimodal touch screen targeting paradigm. For example, the software routines running upon computer 10 may be used to determine based upon sensor data from the touch screen interface, which mode (e.g., direct-targeting or offset-targeting) should be employed at any given time based upon the manner in which the user is engaging the touch screen (e.g., by tip pointing or pad pointing). These routines may be in hardware and/or software and may be implemented in a variety of ways. In common parlance, they may be configured as part of a touch screen driver and/or as part of a GUI controller. A touch screen driver is represented in FIG. 2. Also included is a keypad controller 38 that interrogates the keys 14 to provide signals to the microprocessor 20 corresponding to a key 14 selected by an operator.

The software routines provide unique methods by which to determine whether a user is performing a tip-pointing interaction upon the touch screen or whether the user is performing a pad-pointing interaction upon the touch screen. This method works by assessing sensor data received from the touch screen sensor hardware. As described above, the physical contact between a finger of the user and the touch screen surface generally defines an elliptical area referred to herein as a finger contact area. This finger contact area is represented by data received by the components and/or routines from the touch screen sensor hardware. A processing method is then performed upon the sensor data received from the touch screen sensor hardware for the particular finger contact in question. In such a method, the sensor data received from the touch screen sensor hardware for the particular finger contact in question is assessed to determine if the finger is contacting the screen as a finger-tip interaction or as a finger-pad interaction. A variety of processing methods may be employed, including pattern matching methods, parameter quantification methods, and/or combinations of the methods. Regardless of the specific processing method employed, the general approach is to determine, based upon the size and/or shape of the finger contact area (as represented by the sensor data received from the touch screen sensor hardware), whether the finger contact is a finger-tip interaction or a finger-pad interaction. These two types of interactions are generally easily distinguishable for a given finger of a given user because the finger contact area caused by a finger-tip interaction is substantially smaller in total area, often narrower in shape (i.e., a more eccentric ellipse), and usually has the major axis orientated such that it extends in a direction across the width of the user's finger. Conversely, the finger contact area caused by a finger-pad interaction is substantially larger in total area, often rounder in shape (i.e., a less eccentric ellipse), and usually has the major axis oriented such that it extends in a direction along the length of the user's finger. Thus, one or more of the size, shape, and/or orientation of the detected finger contact area upon the touch screen may be used to distinguish between a tip-pointing interaction of the user versus a pad-pointing interaction of the user. Because finger sizes vary greatly from user to user (and from finger to finger of a given user), some embodiments of the present invention employ a calibration routine to tune the parameters used for distinguishing tip-pointing from pad-pointing specifically to one or more fingers of a particular user. In some embodiments, the users are required to use only a specific finger for the bimodal interface features of the present invention, for example the index finger, as a means of improving the identification accuracy of tip-pointing versus pad-pointing interactions.

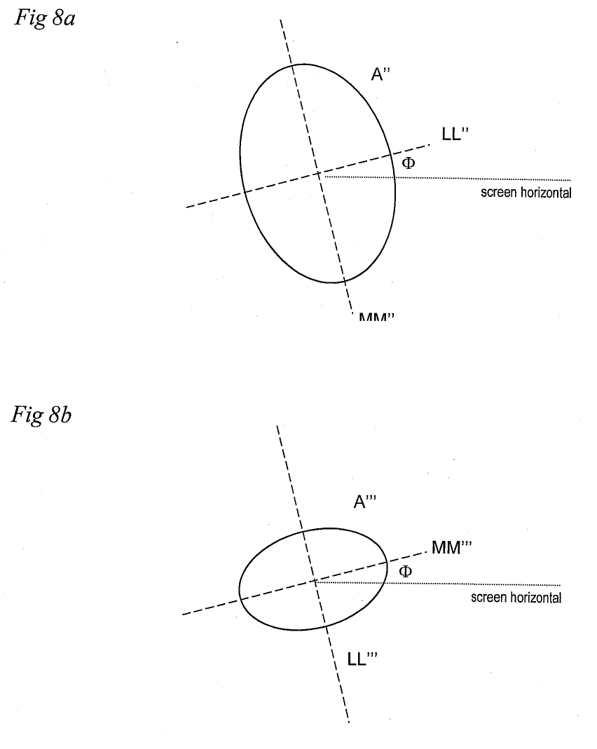

FIGS. 8A and 8B illustrate two example finger contact areas shown as they might be detected by touch screen sensor hardware according to at least one embodiment of the invention. The finger contact area of FIG. 8A is represented by elliptical outline A″ and represents a characteristic finger contact area for a pad-pointing interaction caused by an index finger of a typical user. The finger contact area of FIG. 8B is represented by elliptical outline A′″ and represents a characteristic finger contact area for a tip-pointing interaction as caused by an index finger of a typical user. As can be seen by comparing A″ and A′″, these two area are substantially different in size, shape, and orientation. The tip-pointing interaction as represented by A′″ is substantially smaller in size (both area and circumference), more eccentric in shape (i.e., less rounded), and is oriented such that the major axis MM′″ is oriented closer to the reference screen horizontal. On the other hand, the pad-pointing interaction as represented by A″ is substantially larger in size (both area and circumference), is less eccentric in shape (i.e., more rounded), and is oriented such that the minor axis LL″ is oriented closer to the reference screen horizontal. Thus, each of the size, shape, and/or orientation of the detected finger contact area may be used alone or in combination by the routines of the present invention to distinguish between a tip-pointing interaction and a pad-pointing interaction. They may be evaluated by the routines of the present invention with respect to absolute or relative values. They may be evaluated based only upon current sensor values or may be evaluated also based upon a recent time-history of sensor values. A variety of methods may be used for such evaluation.

Some embodiments of the present invention perform the assessment described above based upon in whole or in part upon a pattern matching technique such that one or more characteristic sensor data patterns is associated with a finger-tip contact and one or more characteristic sensor data patterns is associated with a finger-pad contact. In some embodiments, a user calibration routine is employed in whole or in part to determine and store characteristic sensor data pattern or patterns for a particular user and/or for a particular finger for each of tip-pointing and pad-pointing interactions. Using such a method a current set of sensor data is collected reflecting a finger contact area of for the user upon the touch screen and this data is compared to the characteristic sensor data patterns. Based upon the degree of the match by absolute or relative measures, a determination may be made for the current set of sensor data as to whether or not the associated finger contact is a finger tip contact or a finger pad contact.

In some embodiments, the distinguishing between finger tip contact and finger pad contact is performed based at least in part upon one or more parameters derived from the finger contact sensor data. These parameters may include one or more size parameters, one or more shape parameters, and/or one or more orientation parameters. The size parameters may include an area parameter and/or a circumference parameter for the detected finger contact area. The shape parameters may include an eccentricity parameter and/or roundness parameters for the detected finger contact area. The orientation parameter may include an angle value such as, for example, an angular orientation for the detected finger contact area with respect to a screen reference orientation (such as a horizontal reference orientation for the screen). In some embodiments, these parameters may all be current parameters. In other embodiments these parameters may also include historical values from previous but recent moments in time (e.g., a time-history of parameters derived from recent sensor data readings).

In some such embodiments, the size of the detected finger contact area is used as a primary distinguishing characteristic to determine whether the user is interacting with the tip of his or her finger or with the pad of his or her finger. More specifically, a contact area that is determined to be above a certain size level or threshold, either absolute or relative, may be determined to be a pad interaction and a contact area that is detected to be below a certain size level or threshold, absolute or relative, may be determined by the present invention to be a tip interaction. In addition, the shape of the contact area may also be used as a distinguishing characteristic to determine whether the user is interacting with the tip of his or her finger or with the pad of his or her finger. This is because a tip interaction generally produces a detected contact area that is more eccentric (i.e., narrower) than a pad interaction which generally produces a detected contact area that is less eccentric (i.e., more rounded). Thus, embodiments of the present invention may determine that a detected finger contact area which is above a certain eccentricity level or within certain eccentricity bounds is a tip-pointing interaction and that a detected finger contact area which is below a certain eccentricity level or within other certain eccentricity bounds is a pad-pointing interaction. In addition, both size and shape of the detected contact area may be used in combination to determine if the interaction is a tip-pointing interaction as compared to a pad-pointing interaction. In addition, the orientation of the contact area may also be used as a distinguishing characteristic to determine whether the user is interacting with the tip of his or her finger or with the pad of his or her finger. This is because the major axis of the elliptical shape is generally orientated along a different directional axis for a tip interaction as compared to a pad interaction. A tip interaction generally produces a detected contact area with a major axis that is along the width of the finger while a pad interaction often produces a detected finger contact area that is round (i.e., with no pronounced major axis) or a subtle major axis that is oriented along the length of the finger. Because a user is most likely to have his or finger oriented roughly vertical with respect to the touch screen, the orientation of the major axis may be used as a valuable distinguishing characteristic for tip-pointing versus pad-pointing. Thus, for example, if the orientation of the major axis is closer to the screen horizontal than the screen vertical, the feature suggests that the contact is more likely a tip-pointing contact than a pad-pointing contact. This feature may be assessed in combination with other of the features and/or with a time-history of finger motion, to more accurately make the determination.

In some embodiments, the two modes of interaction are strictly binary in nature, meaning the determination is made that the finger interaction with the touch screen is either tip-pointing or pad-pointing and the mode is abruptly switched between direct-targeting and offset-targeting depending upon which type of pointing is detected. In other embodiments, a gradual transition between direct-targeting and offset-targeting is enabled based upon an analog determination as to the degree of tip-pointing versus pad-pointing. This is because of the existence of a range of possible positions that a user's finger may assume between fully tip-pointing and fully pad-pointing. This range of values is generally “moved through” by the user as he or she rolls his finger from the pad up onto the tip, or rolls his finger from the tip down onto the pad. In some embodiments, a smooth transition between direct-targeting and offset-targeting may be enabled by gradually adjusting the tracking mode used by the graphical interface from direct-targeting to offset-targeting as the user makes this transition from strictly tip-pointing to strictly pad-pointing. In some embodiments this is performed by adjusting the offset distance gradually from 0 (when the user's finger is fully in a tip-pointing mode) to a maximum value (when the user's finger is fully in a pad-pointing mode), and the gradual change is dependent upon the characteristic size, shape, and/or orientation of the detected contact area. For example, as the contact area increases in size and changes in shape as the user's finger transitions from tip-pointing to pad-pointing, the offset distance is increased gradually until the maximum value is reached. Similarly, as the contact area decreases in size and changes in shape as the user's finger transitions from pad-pointing to tip-pointing, the offset distance is decreased gradually until a 0 offset distance is reached. This enables the user to feel as if he or she is not abruptly transitioning between modes, but is selectively controlling the level of offset as he or she rolls from the tip onto the pad of his or her finger (and vice versa).

In such embodiments, as the user rolls his finger from the tip down onto the pad, he or she will see the graphical indicator (e.g., the arrow H shown in FIG. 5) gradually emerge as if it is sliding out from under his or her finger as the offset distance is gradually increased the maximum value. Similarly, as the user rolls his finger from the pad up onto the tip, he or she will see the graphical indicator gradually retract as if it sliding under the user's finger as the offset distance is gradually decreased. This provides for a natural and intuitive method by which to selectively use and/or not use the fine control pointer (i.e., the arrow) when fingering the touch screen.

In some such embodiments, the offset distance is varied proportionally with contact area size between the 0 offset distance value and the maximum offset distance value. In some embodiments, a non-linear scaling is used to vary offset distance with contact area size. In some embodiments the offset distance is varied based upon a combination of the change in size of the contact area and the change in shape of the contact area.

These teachings described herein provided “Trigger Time” embodiments. In some embodiments, the mode shift from direct-targeting to offset-targeting is dependent upon an amount of time elapsing after the user makes finger contact the screen. More specifically, in some embodiments, the mode shift from direct-targeting to offset-targeting is conditional upon the elapsed after the user makes finger contact with the screen being more than certain threshold amount of time. For example, a user reaches forward and touches the screen surface with a pad-pointing interaction. The user then maintains finger contact with the touch screen for a period of time with that particular finger. The software according to the present invention determines, based upon the size, shape, and/or orientation of the detected contact area, that the finger contact is a pad-pointing interaction. In addition, upon finger contact, the software begins a timer or otherwise tracks the elapsed time from the approximate moment when the user initiated the contact with the screen using the particular finger. The software implements a direct-targeting interaction mode until it is determined that the elapsed time has exceeded the defined time threshold and then shifts to an offset-pointing interaction mode. In this way a threshold amount of time must elapse after a particular finger contacts the screen, during which time the finger contact is maintained, in order for the routines of the present invention to shift from a direct-targeting interaction mode to an offset-targeting interaction mode.

In one example implementation of such an embodiment, the software always implements a direct-targeting interaction mode upon an initial contact between a finger and the touch screen surface regardless of whether the contact is made with the tip or the pad of the finger. If the finger maintains contact with the touch screen surface for more than a threshold amount of time, the targeting mode automatically transitions from direct-targeting to offset-targeting so long as any other required conditions are also met at that time. For example, if the other required condition is that the finger must be in a pad-pointing mode, then that condition must also be met for the transition to occur. Thus, in such an embodiment, a user may contact the screen with the pad of his or her finger and maintain contact for an extended period. A direct targeting mode is initially enacted by the software of the present invention but as soon as the threshold amount of time has elapsed since initial contact, the software switches to offset targeting so long as the finger remains in pad contact with the screen. If the user rolls his finger forward to tip contact with the screen, the software transitions back to direct targeting without any trigger time requirement. If the user then rolls his finger back to pad contact with the screen, the software transition back to offset targeting without any trigger time requirement (so long as contact has been maintained continuously with the screen).

In one specific example embodiment, the defined time threshold is 2200 milliseconds. In this way, the user must engage the screen with a finger and maintain continuous finger contact with the screen interaction for at least 2200 milliseconds in order for an offset-targeting mode to be enacted. Prior to the 2200 milliseconds time period elapsing, a direct-targeting interaction mode is implemented. In addition, this particular example embodiment also requires that the user's finger be pad-pointing for offset-targeting to be enacted. Thus, in some embodiments of the present invention, two condition must be met for offset-pointing to be implemented by the routines—(a) the user must be interacting with the screen through pad-pointing (as opposed to tip-pointing), and (b) the user must have maintained contact with the screen for more than a threshold amount of time.

A benefit of such Trigger Time embodiments of the present invention is that a user may reach out and touch an element upon a touch screen with either a tip-pointing or pad-pointing interaction and select that element through direct targeting so long as the selection happens prior to the threshold time requirement. This makes sense because direct targeting is well adapted for course targeting actions that are generally rapid in nature while offset-targeting is well adapted for fine targeting actions that are generally slow and deliberate in nature. Thus, a user can quickly reach out and push a large button upon a touch screen through direct-targeting, but if a user wants to carefully select a few letters of text, he or she can maintain the required form of contact with the screen for more than the required threshold amount of time. Once that threshold has elapsed, the offset targeting mode is enacted. This is immediately made apparent to the user with the display of the graphical indicator (i.e., the graphical arrow as shown in FIG. 5) appearing forward of the user's finger. The user can then position the arrow at or upon the desired letter by sliding his or her finger upon the screen. In some embodiments the user is enabled to select the desired letter by applying a force against the screen that is above a certain threshold while maintaining targeting alignment of the graphical indicator.

Multi-Point embodiments are also provided by the teachings discussed herein. Although the primary descriptions above refer to a single finger contact with the touch screen surface, the methods described can be applied to multi-point touch screen surfaces that can simultaneously sense the presence of a plurality of finger contacts. For such embodiments, each finger contact may be independently assessed to determine if it is a tip-pointing interaction or a pad-pointing interaction. In some instances, multi-finger gestures may be defined that are dependent not only upon the placement and motion of multiple fingers, but also upon the determination of whether one or more fingers in the multi-finger gesture is implementing a tip-pointing interaction or a pad-pointing interaction. For example, by using the determination processes disclosed herein, a double finger gesture in which both fingers contact the screen upon their tips may be determined to be different and thereby cause a different action that a double finger gesture that is otherwise the same but in which both fingers contact the screen upon their pads.

In addition, some embodiments of the present invention may determine thumb contacts as being separate and differing from other fingers based upon the size and shape of the contact area caused by thumb. In this way, for example, a user may use the index finger of one hand to perform tip-pointing and/or pad-pointing interactions (as described above), while the thumb of the other hand acts upon the touch screen to supply “click” used in the section of items which are pointed at.

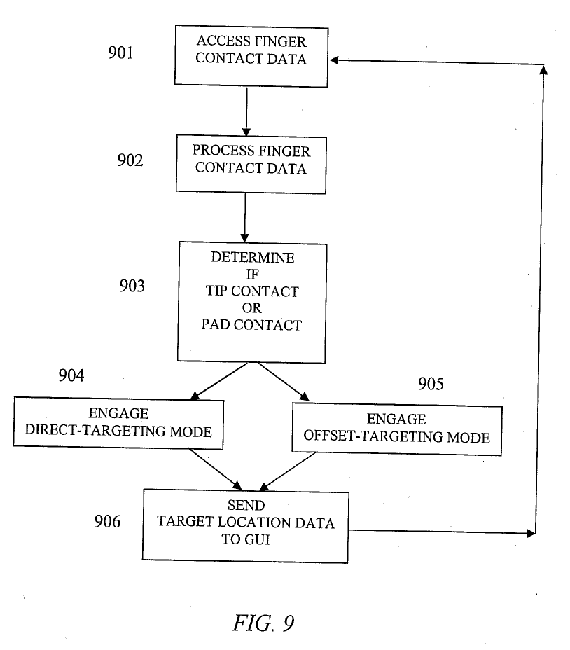

FIG. 9 illustrates a flow chart of an example process that may be employed according to at least one embodiment of the present invention. The process starts at 901 where finger contact data is accessed from touch screen sensor hardware. The process proceeds to step 902 where finger contact data is processed. This step may include determining parameters such as a size, shape, and/or orientation parameter for the finger contact area. The process proceeds to step 903 where the processed finger contact data is compared against known patterns, thresholds, and/or criteria as described previously to determine if the finger contact of the user is a tip-pointing contact (i.e., is with the tip of the user's finger) or a pad-pointing contact (i.e., is with the pad of the user's finger). If it is determined at 903 to be a tip-contact, the process proceeds to step 904 wherein a direct-targeting mode is engaged. At this step a target location is computed such that it is within the contact area of the finger. It many embodiments it is at or near the center of the finger contact area. Alternately, if it is determined at 903 that the contact is a pad contact, the process proceeds to 905 wherein an offset-targeting mode is engaged. At this step an offset target location is computed, as described previously, that is not within the contact are of the finger. Instead, the target location is in front of the finger (i.e., ahead of the nail of the finger) by an offset distance as described previously. At step 906 data is communicated to the GUI of the present system. The data includes target location data. This target location data may be direct-targeting data or offset-targeting data depending upon which mode is currently active. A status flag or other indicator may also be sent to the GUI to communicate which mode is currently active. This status flag may be used by the GUI, if it indicates that an offset-pointing mode is active, to draw a graphical indicator that points to the offset target location as shown in FIG. 5. In some embodiments the drawing of the graphical indicator may be handled elsewhere in the process. After step 906 the process repeats by looping back to 901. This process will cycle repeatedly over an extended period of time, preferably at a rapid rate.

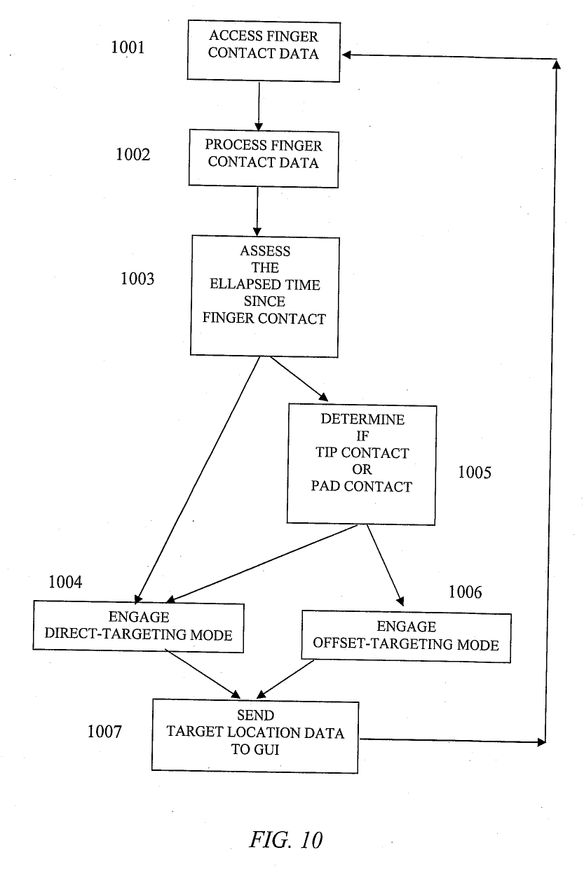

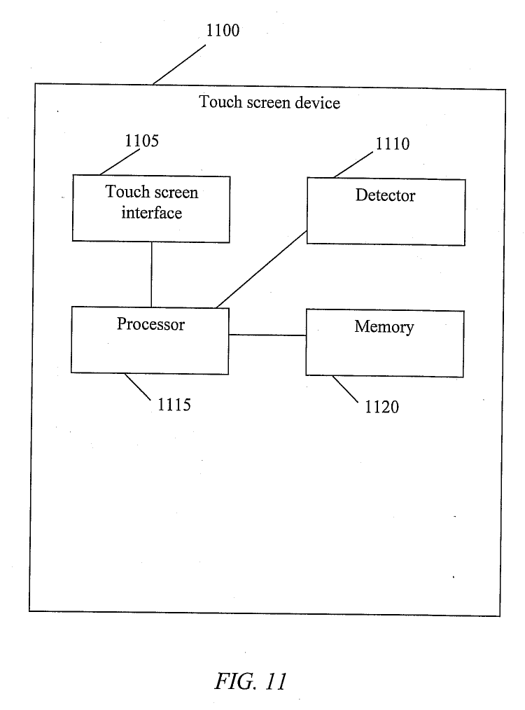

FIG. 10 illustrates a flow chart for other example processes that may be employed according to at least one embodiment of the present invention. The process starts at step 1001 where finger contact data is accessed from touch screen sensor hardware. The process proceeds to step 1002 where finger contact data is processed. This step may include determining parameters such as a size, shape, and/or orientation parameter for the finger contact area. This step may also include initiating a timer or other counting mechanism to track elapsed time if it is determined in step 1002 that the finger contact area is a new finger contact. By “new finger contact area,” it is meant that the finger was not detected as contacting the screen at an immediately previous time but instead is a new contact between the finger and the screen. This is apparent by a finger contact area suddenly appearing within the data received from the touch screen sensor interface.

The process then proceeds to step 1003 where the elapsed time as measured by the timer or other counting mechanism is assessed. This elapsed time is an indication of how long a particular finger contact (as represented by the finger contact sensor data) has been in continuous contact with the touch screen surface. If the elapsed time is less than a defined threshold amount of time (e.g., 2200 milliseconds), the process proceeds to step 1004 where a direct-targeting mode is automatically engaged. If the elapsed time is more than the defined threshold amount of time, the process then proceeds to step 1005 where any additional required parameters are assessed. In this particular inventive embodiment, the additional required parameter for offset-targeting is that the user be engaged in pad-pointing. It should be appreciated that in certain embodiments, step 1005 may be removed and the process may flow directly from steps 1003 to 1006 if the elapsed time is determined to be greater than the time threshold.)

In the current embodiment, step 1005 is configured such that processed contact data is assessed to determine whether the user is engaged in a pad-pointing or tip-pointing interaction. Thus, at step 1005 the processed finger contact data is compared against known patterns, thresholds, and/or criteria as described previously to determine whether the finger contact of the user is a tip-pointing contact (i.e., is with the tip of the user's finger) or a pad-pointing contact (i.e., is with the pad of the user's finger). If it is determined at 1005 to be a tip-contact, the process proceeds to step 1004 wherein a direct-targeting mode is engaged. At this step a target location is computed such that it is within the contact area of the finger. In many embodiments it is at or near the center of the finger contact area. Alternately, if it is determined at step 1005 that the contact is a pad contact, the process proceeds to step 1006 where an offset-targeting mode is engaged. At this step an offset target location is computed, as described previously, that is not within the contact are of the finger. Instead, the target location is in front of the finger (i.e., ahead of the nail of the finger) by an offset distance as described previously. At step 1007 data is communicated to the GUI of the present system. The data includes target location data. This target location data may be direct-targeting data or offset-targeting data depending upon which mode is currently active. A status flag or other indicator may also be sent to the GUI to communicate which mode is currently active. This status flag may be used by the GUI, if it indicates that an offset-pointing mode is active, to draw a graphical indicator that points to the offset target location as shown in FIG. 5. In some embodiments the drawing of the graphical indicator may be handled elsewhere in the process. After step 1007 the process repeats by looping back to step 1001. This process will cycle repeatedly over an extended period of time, preferably at a rapid rate.

FIG. 11 illustrates a touch screen device 1100 according to at least one embodiment of the invention. The touch screen device 1100 provides for bi-modal user interaction. The touch screen device 1100 includes a touch screen interface 1105. A detector 1100 detects an area of finger interaction with the touch screen surface. A processor 1115 is adapted to determine, based on at least one of a size, a shape, and an orientation of the detected area of finger interaction, whether a current finger interaction is of one of: a finger-tip interaction type and a finger-pad interaction type. The processor 1115 also selects and implements, based on a determined interaction type, one of two different targeting modes, including a first targeting mode selected and implemented in response to a determined finger-tip interaction type and a second targeting mode selected and implemented in response to a determined finger-pad interaction type. A memory 1120 contains a computer-readable program code encoded thereon which, when executed by the processor 1115, causes the processor 1115 and/or the touch screen device 1100 to implement various method described above.

It should be noted that the time threshold used by the processes described above may be user selectable and/or adjustable through a configuration process of the present invention. The configuration process may involve the user adjusting and/or setting parameters on a configuration control panel page provided upon the computer of the present invention. In this way the user can set the time threshold to a value that is most natural for him or her.

The foregoing description of preferred embodiments of the present invention provides illustration and description, but is not intended to be exhaustive or to limit the invention to the precise form disclosed. This invention has been described in detail with reference to various embodiments. It should be appreciated that the specific embodiments described are merely illustrative of the principles underlying the inventive concept. It is therefore contemplated that various modifications of the disclosed embodiments will, without departing from the spirit and scope of the invention, be apparent to persons of ordinary skill in the art.

Other embodiments, combinations and modifications of this invention will occur readily to those of ordinary skill in the art in view of these teachings. Therefore, this invention is not to be limited to the specific embodiments described or the specific figures provided. This invention has been described in detail with reference to various embodiments. Not all features are required of all embodiments. It should also be appreciated that the specific embodiments described are merely illustrative of the principles underlying the inventive concept. It is therefore contemplated that various modifications of the disclosed embodiments will, without departing from the spirit and scope of the invention, be apparent to persons of ordinary skill in the art. Numerous modifications and variations could be made thereto by those skilled in the art without departing from the scope of the invention set forth in the claims.

What is claimed is:

1. A method of bi-modal touch screen interaction for a touch screen device, the method comprising:
detecting an area of finger interaction upon a touch screen surface;
determining, based on at least one of a size, a shape, and an orientation of the detected area of finger interaction, whether the finger interaction is one of: a finger-tip interaction type and a finger-pad interaction type; and
implementing, based on the determined interaction type, one of two different targeting modes, including a first targeting mode implemented in response to a determined finger-tip interaction type and a second targeting mode implemented in response to a determined finger-pad interaction type.

2. The method as recited in claim 1 wherein the first targeting mode provides a targeting location within the area of finger interaction, and the second targeting mode provides a targeting location outside of the area of finger interaction.

3. The method as recited in claim 2 wherein the first targeting mode provides the targeting location under a user's finger and thereby permits a user to target graphical user interface elements located under the user's finger.

4. The method as recited in claim 2 wherein the second targeting mode provides the targeting location forward of a user's finger and thereby permits a user to target graphical user interface elements located forward of the user's finger.

5. The method as recited in claim 4 wherein a graphical cursor element is displayed during the second targeting mode to indicate visually to the user the targeting location forward of the user's finger.

6. The method as recited in claim 4 wherein the targeting location forward of the user's finger is located a distance forward of the user's finger, the distance being determined at least in part based on the size of the detected area of finger interaction.

7. The method as recited in claim 3 wherein the targeting location used by the first targeting mode is located substantially near a geometric center of the detected area of finger interaction.

8. The method as recited in claim 1 wherein a first graphical cursor element type is displayed during the first targeting mode and a second graphical cursor element type is displayed during the second targeting mode.

9. The method as recited in claim 1 wherein a graphical cursor is displayed only during the second targeting mode.

10. The method as recited in claim 1 wherein the detected area of finger interaction is approximately a shape of an ellipse and wherein the determination of the finger interaction is performed based at least in part on an assessment of at least one of a major axis of the ellipse, a minor axis of the ellipse, and an orientation of the ellipse.

11. The method as recited in claim 1 further comprising dynamically changing from the first targeting mode to the second targeting mode in response to determining that a user has rolled a finger from the finger-tip interaction type to the finger-pad interaction type.

12. The method as recited in claim 1 further comprising dynamically changing from the second targeting mode to the first targeting mode in response to determining that a user has rolled a finger from the finger-pad interaction type to the finger-tip interaction type.

13. The method as recited in claim 1 wherein the determining is based on at least two of the size, shape, and orientation of the area of finger interaction.

14. The method as recited in claim 2 wherein the targeting location employed by the second targeting mode is determined at least in part based on a substantially current orientation of the area of finger interaction.

15. The method as recited in claim 2 wherein the targeting location employed by the second targeting mode is determined at least in part based on data from an orientation sensor responsive to a spatial orientation of the touch screen device.

16. The method as recited in claim 1 wherein implementing the second targeting mode is further dependent upon an elapsed time of finger interaction exceeding a time threshold.

17. A touch screen device for providing bi-modal user interaction, the touch screen device comprising:
a display screen;
a detector to detect an area of finger interaction with the display screen; and
a processor to
determine, based on at least one of a size, a shape, and an orientation of the detected area of finger interaction, whether a current finger interaction is one of: a finger-tip interaction type and a finger-pad interaction type, and
implement, based on a determined interaction type, one of two different targeting modes, including a first targeting mode implemented in response to a determined finger-tip interaction type and a second targeting mode implemented in response to a determined finger-pad interaction type.

18. The touch screen device of claim 17 wherein the first targeting mode provides a targeting location within the area of finger interaction, and the second targeting mode provides the targeting location outside of the area of finger interaction.

19. The touch screen device of claim 18 wherein the second targeting mode provides the targeting location forward of a user's finger and wherein a graphical cursor element is displayed upon the display screen during the second targeting mode to indicate visually to the user the targeting location forward of the user's finger.

20. The touch screen device of claim 19 wherein the targeting location forward of the user's finger is located a distance forward of the user's finger, and the distance is determined, at least in part, based on the size of the detected area of finger interaction.

21. The touch screen device of claim 18 wherein the first targeting mode provides the targeting location that comprises a point or area substantially near a geometric center of the detected area of finger interaction.

22. The touch screen device of claim 17 wherein a first graphical cursor element type is displayed during the first targeting mode and a second graphical cursor element type is displayed during the second targeting mode.

23. The touch screen device of claim 17 wherein the processor is adapted to dynamically change from the first targeting mode to the second targeting mode in response to a determination that a user has rolled a finger from the finger-tip interaction type to the finger-pad interaction type.

24. The touch screen device of claim 18 wherein the targeting location employed by the second targeting mode is determined, at least in part, based on a substantially current orientation of the area of finger interaction.

25. The touch screen device of claim 17 wherein implementing the second targeting mode is further dependent upon an elapsed time of finger interaction exceeding a time threshold.

26. The touch screen device of claim 18 wherein the processor is adapted to enable a user to select a targeted graphical element when engaged in the second targeting mode by momentarily lifting and tapping the finger of detected interaction upon the touch screen surface.

27. The touch screen device of claim 17 wherein the processor is adapted to enable a user to select a targeted graphical element when engaged in the second targeting mode by touching an additional finger upon the touch screen surface to indicate a click event.

28. A method of bi-modal user interaction for a touch screen device, the method comprising:
detecting an area of finger interaction upon a touch screen surface;
repeatedly determining, for the detected area of finger interaction, an elapsed time of continuous interaction with the touch screen surface; and
implementing, based upon a currently determined elapsed time, one of two different targeting modes, including a first targeting mode to implement in response to an elapsed time being less than threshold value and a second targeting mode to implement in response to the elapsed time being greater than the threshold value.

29. The method as recited in claim 28 wherein the first targeting mode provides a targeting location within the area of finger interaction, and the second targeting mode provides the targeting location outside of the area of finger interaction.

30. The method as recited in claim 29 wherein the first targeting mode provides the targeting location under a user's finger and thereby permits the user to target graphical user interface elements located under the user's finger.

31. The method as recited in claim 29 wherein the second targeting mode provides the targeting location forward of the user's finger and thereby permits the user to target graphical user interface elements located forward of the user's finger.

32. The method as recited in claim 31 wherein a graphical cursor element is displayed during the second targeting mode to indicate visually to the user the targeting location forward of the user's finger.

33. The method as recited in claim 31 wherein the targeting location forward of the user's finger is located a distance forward of the user's finger, the distance being determined at least in part based on the size of the detected area of finger interaction.

34. The method as recited in claim 30 wherein the targeting location used by the first targeting mode is located substantially near a geometric center of the detected area of finger interaction.

35. The method as recited in claim 29 wherein a first graphical cursor element type is displayed during the first targeting mode and a second graphical cursor element type is displayed during the second targeting mode.

36. The method as recited in claim 29 wherein the targeting location employed by the second targeting mode is determined at least in part based on a substantially current orientation of the area of finger interaction.

37. The method as recited in claim 29 wherein the targeting location employed by the second targeting mode is determined at least in part based on data from an orientation sensor responsive to a spatial orientation of the touch screen device.

38. The method of claim 29 wherein a user is enabled to select a targeted graphical element when engaged in the second targeting mode by momentarily lifting and tapping a finger of detected interaction upon the touch screen surface.

39. The method of claim 29 wherein a user is enabled select a targeted graphical element when engaged in the second targeting mode by pressing down with an interaction finger to impart a force level that exceeds a threshold value.

40. The method of claim 29 wherein a user is enabled to select a targeted graphical element when engaged in the second targeting mode by touching an additional finger upon the touch screen surface to indicate a click event.
